(19) United States
(12) Patent Application Publication
(10) Pub. No.: US 2012/0153217 A1
(43) Pub. Date: Jun. 21, 2012

(54) THERMALLY CONDUCTIVE POLYMERIC RESIN COMPOSITION

(75) Inventor: Yuji Saga, Utsunomiya-shi (JP)

(73) Assignee: E.I.DU PONT DE NEMOURS AND COMPANY, Wilmington, DE (US)

(21) Appl. No.: 13/316,615

(22) Filed: Dec. 12, 2011

Related U.S. Application Data
(60) Provisional application No. 61/424,806, filed on Dec. 20, 2010.

(51) Int. Cl. C09K 5/14

(52) U.S. Cl. 252/75

(57) ABSTRACT

Thermally conductive polymer resin compositions comprising polymer, calcium fluoride, fibrous filler and optionally, to polymeric toughening agent are particularly useful for producing composite members having metal members and polymer resin members.

### CROSS REFERENCE TO RELATED APPLICATIONS

This application claims the benefit of priority to U.S. Provisional Application No. 61/424,806, filed Dec. 20, 2010.

### FIELD OF THE INVENTION

Thermally conductive plastic resin compositions comprising polyamide and combination of calcium fluoride modified with coupling agent and fibrous filler are useful as components for electric and electronics devices which require thermal management.

### BACKGROUND OF THE INVENTION

Because of their excellent mechanical and electrical insulation properties, polymeric resin compositions are used in a broad range of applications such as in automotive parts, electrical and electronic parts, machine parts and the like. In many cases, because of the design flexibility they permit, sealing capability and their electrical insulation properties, polymer resin compositions can be used as encapsulants, housings and frames for electrical and electronics devices or motors. Also, there has recently been more interest in composite members which include both metal members and resin members to utilize the respective characteristics of both metal and resin. Further, not only are electrical insulation properties needed in the encapsulating polymer compositions, but they also often need to have higher thermal conductivities especially with the downsizing trend of some electrical devices. Another important requirement for encapsulating polymer compositions which have inherently high coefficient of thermal expansion, is that their Coefficients of Linear Thermal Expansions (CLTEs) should be close to CLTEs of materials such as metals encapsulated with the polymer compositions to retain seal integrity while releasing heat generated by the encapsulated devices since the resulting composite members tend to separate due to the difference in coefficients of linear expansion With higher loading with thermally conductive filler in polymer to improve coefficient of linear expansion of thermoplastic resin compositions, which is well known technique, it leads to higher thermal conductivity and lower CLTE because the fillers' CLTEs are often lower than polymers' CLTEs. However, high filler loadings often decreases flow-ability of polymer compositions in melt forming processes, and that can lead to failure of sealing performance or damage of core devices encapsulated with the polymer compositions. Another important requirement for housings or frames is mechanical strength. Thus, polymer composition having higher thermal conductivity, electrically insulation, lower CLTE, higher mechanical strength, higher ductility and good flowability is desired.

With respect to techniques for improving CLTEs of thermoplastic resin compositions and its thermal conductivity, Japanese patent application publication 2003-040619 discloses a method of surface treating calcium fluoride powder with a silane coupling agent and blending the coated powder with thermoplastic resins and, optionally, fillers to produce a thermally conductive composition. However, CLTEs obtained in the compositions are not so much low, and mechanical strength and stiffness are not enough to be used as structural parts.

It has also been disclosed in US patent application publication 2005-176835 and Japanese patent application publication 2003-040619 disclose polymer compositions comprising thermoplastic polymer and calcium fluoride and, optionally, fibrous fillers to produce a thermally conductive composition. However, CLTEs obtained in the compositions are not so much low, and mechanical strength and stiffness are not enough to be used as structural parts.

There remains a need for thermoplastic resin compositions, which exhibit improved thermal conductivity as well as low CTLEs and maintained or improved mechanical properties, with incorporating calcium fluoride into thermoplastic polymer.

It is an object of this invention to provide a thermally conductive polymer composition which exhibits high mechanical strength and a low coefficients of linear thermal expansion, while retaining excellent mechanical and electrical insulation properties of thermoplastic resin compositions, and which is suitable for producing composite members which include both metal members and resin members.

### SUMMARY OF THE INVENTION

There is disclosed and claimed herein a thermally conductive polymer composition, comprising:
(a) about 15 to about 65 weight percent of polyamide,
(b) about 20 to about 55 weight percent of calcium fluoride,
(c) about 10 to about 30 weight percent of at least one electrically insulative fibrous filler, and
(d) 0 to about 15 weight percent of polymeric toughening agent.
wherein the calcium fluoride (b) is coated with a coupling agent selected from the group consisting of slime series, titanate series, zirconate series, aluminate series, and zircoaluminate series. and the composition is characterized by the fact that a ratio of coefficients of linear thermal expansion (CLTEs) in the mold flow direction (MD) of a molded article made therefrom to its tensile elongation is 19 ppm/° C. % or lower, wherein the CLTE is measured between −40 and 150° C. using ASTM D696 method,

the above stated percentages being based on the total weight of the composition.

### DETAILED DESCRIPTION OF THE INVENTION

The composition of the present invention comprises (a) polyamide, (b) calcium fluoride, (c) fibrous filler, and optionally (d) at least one polymeric toughening agent.

### (a) Polyamide Resin

The polyamides used in the compositions described herein may one or more semi-crystalline polyamide, amorphous polyamide, or a mixture of these. The semi-crystalline polyamide includes aliphatic or semi-aromatic semi-crystalline polyamides.

The semi-crystalline aliphatic polyamide may be derived from aliphatic and/or alicyclic monomers such as one or more of adipic acid, sebacic acid, azelaic acid, dodecanedoic acid, or their derivatives and the like, aliphatic C₆-C₂₀ alkylenediamines, alicyclic diamines, lactams, and amino acids. Preferred diamines include bis(p-aminocyclohexyl)methane; hexamethylenediamine; 2-methylpentamethylenediamine; 2-methyloctamethylenediamine; trimethylhexamethylenediamine; 1,8-diaminooctane; 1,9-diaminononane; 1,10-diaminodecane; 1,12-diaminododecane; and m-xylylenediamine. Preferred lactams or amino acids include 11-aminododecanoic acid, caprolactam, and laurolactam.

Preferred aliphatic polyamides include polyamide 6; polyamide 6,6; polyamide 4,6; polyamide 6,10; polyamide 6,12; polyamide 11; polyamide 12; polyamide 9,10; polyamide 9,12; polyamide 9,13; polyamide 9,14; polyamide 9,15; polyamide 6,16; polyamide 9,36; polyamide 10,10; polyamide 10,12; polyamide 10,13; polyamide 10,14; polyamide 12,10; polyamide 12,12; polyamide 12,13; polyamide 12,14; polyamide 6,14; polyamide 6,13; polyamide 6,15; polyamide 6,16; and polyamide 6,13.

The semi-aromatic semi-crystalline polyamides are one or more homopolymers, copolymers, terpolymers, or higher polymers that are derived from monomers containing aromatic groups. Examples of monomers containing aromatic groups are terephthalic acid and its derivatives. It is preferred that about 5 to about 75 mole percent of the monomers used to make the aromatic polyamide used in the present invention contain aromatic groups, and it is still more preferred that about 10 to about 55 mole percent of the monomers contain aromatic groups.

Examples of preferred semi-crystalline semi-aromatic polyamides include poly(m-xylylene adipamide) (polyamide MXD,6), poly(dodecamethylene terephthalamide) (polyamide 12,T), poly(decamethylene terephthalamide) (polyamide 10,T), poly(nonamethylene terephthalamide) (polyamide 9,T), hexamethylene adipamide/hexamethylene terephthalamide copolyamide (polyamide 6,T/6,6), hexamethylene terephthalamide/2-methylpentamethylene terephthalamide copolyamide (polyamide 6,T/D,T); hexamethylene terephthalamide/decamethylene dodecaneamide copolyamide (polyamide 6,T/10,12); hexamethylene terephthalamide/decanethylene decaneamide copolyamide (polyamide 6,T/10,10); hexamethylene adipamide/hexamethylene terephthalamide/hexamethylene isophthalamide copolyamide (polyamide 6,6/6,T/6,I); poly(caprolactam-hexamethylene terephthalamide) (polyamide 6/6,T); and the like.

Preferred semi-crystalline semi-aromatic polyamides include hexamethylene terephthalamide/2-methylpentamethylene terephthalamide copolyamide (polyamide 6,T/D,T), and preferably having 45-55 mol % repeat units 6,T and 55-45 mol % repeat units D,T.

In the present invention, a semi-crystalline semi-aromatic polyamide is preferred in terms of heat resistance, dimension stability and moisture resistance at high temperature

In the present invention, amorphous polyamides can be contained in the polymer composition without giving significant negative influence on the properties. They are one or more homopolymers, copolymers, terpolymers, or higher polymers that are derived from monomers containing isophthalic acid and/or dimethyldiaminodicyclohexylmethane groups.

In the preferred amorphous polyamide, the polyamide consists of a polymer or copolymer having repeating units derived from a carboxylic acid component and an aliphatic diamine component. The carboxylic acid component is isophthalic acid or a mixture of isophthalic acid and one or more other carboxylic acids wherein the carboxylic acid component contains at least 55 mole percent, based on the carboxylic acid component, of isophthalic acid. Other carboxylic acids that may be used in the carboxylic acid component include terephthalic acid and adipic acid. The aliphatic diamine component is hexamethylene diamine or a mixture of hexamethylene diamine and 2-methyl pentamethylene diamine and/or 2-ethyltetramethylene diamine, in which the aliphatic diamine component contains at least 40 mole percent, based on the aliphatic diamine component, of hexamethylene diamine.

Examples of preferred amorphous polyamides include poly(hexamethylene terephthalamide/hexamethylene isophthalamide) (polyamide 6,T/6,I), poly(hexamethylene isophthalamide) (polyamide 6,I), poly(metaxylylene isophthalamide/hexamethylene isophthalamide) (polyamide MXD,I/6,I), poly(metaxylylene isophthalamide/metaxylylene terephthalamide/hexamethylene isophthalamide) (polyamide MXD,I/MXD,T/6,I/6,T), poly(metaxylylene isophthalamide/dodecamethylene isophthalamide) (polyamide MXD,I/12,I), poly(metaxylylene isophthalamide) (polyamide MXD,I), poly(dimethyldiaminodicyclohexylmethane isophthalamide/dodecanamide) (polyamide MACM,I/12), poly(dimethyldiaminodicyclohexylmethane isophthalamide/dimethyldiaminodicyclohexylmethane terephthalamide/dodecanamide) (polyamide MACM,I/MACM,T/12), poly(hexamethylene isophthalamide/dimethyldiaminodicyclohexylmethane isophthalamide/dodecanamide) (polyamide 6,I/MACM,I/12), poly(hexamethylene isophthalamide/hexamethylene terephthalamide/dimethyldiaminodicyclohexylmethane isophthalamide/dimethyldiaminodicyclohexylmethane terephthalamide) (polyamide 6,I/6,DMACM,I/MACM,T), poly(hexamethylene isophthalamide/hexamethylene terephthalamide/dimethyldiaminodicyclohexylmethane isophthalamide/dimethyldiaminodicyclohexylmethane terephthalamideldodecanamide) (polyamide 6,I/6,T/MACM,I/MACM,T/12), poly(dimethyldiaminodicyclohexylmethane isophthalamide/dimethyldiaminodicyclohexylmethane dodecanamide) (polyamide MACM,I/MACM,12) and mixtures thereof.

When an amorphous polyamide is contained, the semicrystalline polyamide is present in about 40 to about 100 (and preferably about 70 to about 100) weight percent, based on the total amount of semicrystalline and amorphous polyamide present.

The semi-aromatic polyamides useful in the invention have a glass transition equal to or greater than 100° C., preferably greater than 115° C.; and a melting point of equal to or greater than 280° C., and preferably greater than 290° C., and more preferably greater than 300° C. The glass transition and melting points defined herein are determined using differential scanning calorimetry at a scan rate of 20° C./min. The glass transition is defined as the midpoint of the transition in the second heating cycle. The melting point is defined as the point of maximum endotherm in the melting transition in the second heating cycle.

The polyamide (a) is present inform at or about 15 to at or about 65 weight percent, preferably from at or about 20 to at or about 60 weight percent, and more preferably in about from at or about 20 to at or about 50 weight percent, based on the total weight of the composition.

### (b) Calcium Fluoride

The calcium fluoride used as component (b) in the present invention will preferably be in the form of a powder. The particles or granules can have a broad particle size distribution. Preferably, maximum particle size is less than 300 μm, and more preferably less than 200 μm. Average particle size of the said calcium fluoride will be from 0.1 μm to 60 μm, and preferably, from 1 to 40 μm, and more preferably from 1 to 20 μm for the reason that smaller particle is better for strength and elongation that leads to higher heat shock resistance. The particles which have multi-modal size distribution in their particle size can also be used.

The surface of the calcium fluoride (b) will be processed with a coupling agent, for the purpose of improving the interfacial bonding between the magnesium oxide surface and the matrix polymer. Examples of the coupling to agent include silane series, titanate series, zirconate series, aluminate series, and zircoaluminate series coupling agents.

Useful coupling agents include metal hydroxides and alkoxides including those of Group IIIa thru VIIIa, Ib, IIb, IIIb, and IVb of the Periodic Table and the lanthanides. Specific coupling agents are metal hydroxides and is alkoxides of metals selected from the group consisting of Ti, Zr, Mn, Fe, Co, Ni, Cu, Zn, Al, and B. Preferred metal hydroxides and alkoxides are those of Ti and Zr. Specific metal alkoxide coupling agents are titanate and zirconate orthoesters and chelates including compounds of the formula (I), (II) and (III):

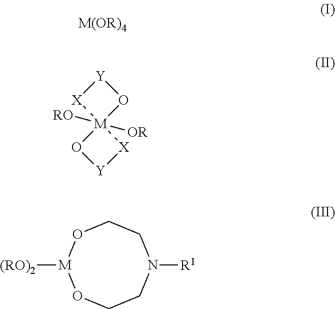

wherein

### M is Ti or Zr;

R is a monovalent C₁-C₈ linear or branched alkyl;
Y is a divalent radical selected from —CH(CH₃)—, —C(CH₃)═CH₂—, or —CH₂CH₂—;
X is selected from OH, —N(R¹)₂, —C(O)OR³, —C(O)R³, —CO₂⁻A⁺; wherein
R¹ is a —CH₃ or C₂-C₄ linear or branched alkyl, optionally substituted with a hydroxyl or interrupted with an ether oxygen; provided that no more than one heteroatom is bonded to any one carbon atom;
R³ is C₁-C₄ linear or branched alkyl;
A⁺ is selected from NH₄⁺, Li⁺, Na⁺, or K.

The coupling agent can be added to the filler before mixing the filler with the resin, or can be added while blending the filler with the resin. The additive amount of coupling agent is preferably 0.1 through 5 wt % or preferably 0.5 through 2 wt % with respect to the weight of the calcium fluoride. Addition of the coupling agent during the blending of the calcium fluoride with the resin has the added advantage of improving the adhesiveness between the metal used in the joint surface between the heat transfer unit or heat radiating unit and the thermally conductive resin.

The calcium fluoride (b) is added to the polyamide resin in an amount from at or about 20 to at or about 55 weight percent, preferably from at or about 25 weight percent to at or about 50 weight percent, and more preferably in about from at or about 30 weigh percent to at or about 45 weight percent, based on the total weight of the composition.

### (c) Fibrous Filler

The fibrous filler used as component (c) in the present invention is a needle-like fibrous material. Examples of preferred fibrous fillers include wollastonite (calcium silicate whiskers), glass fibers, aluminum borate fibers, calcium carbonate fibers, titanium oxide fibers, alumina fibers and potassium titanate fibers. The fibrous filler will preferably have a weight average aspect ratio of at least 5, or more preferably of at least 10.

In the similar way processed on the surface of the calcium fluoride (b), the surface of the fibrous filler (c) can be processed with a coupling agent, for the purpose of improving the interfacial bonding between the fibrous fillers and the matrix polymer.

Component (c) is added to the polyamide resin in an amount from at or about 10 weigh percent to at or about 30 weight percent, preferably from at or about 15 weight percent to at or about 30 weight percent, based on the total weight of the composition. If its content is less than 10 weight percent, enough mechanical strength and low CLTE can't be obtained. If its content is more than 30 weight percent, flowability and thermal conductivity of the resin composition get worse.

Preferably, the weight ratio of (b)/(c) is preferably between 40/60 and 90/10, or more preferably between 50/50 and 80/20. If the ratio is less than 40/60, thermal conductivity of the composition will become low, and if the ratio is more than 90/10, heat shock resistance and mechanical strength of the composition will be deteriorated.

### (d) Polymeric Toughening Agent

The polymeric toughening agent optionally used in the present invention is any toughening agent that is effective for the polyamide used.

As an example of the toughening agent, a copolymer of ethylene and a (meth)acrylate monomer and the copolymers containing the functional group is which can react with polyamide. By (meth)acrylate herein is meant the compound may be either an acrylate, a methacrylate, or a mixture of the two. Useful (meth)acrylate functional compounds include (meth)acrylic acid, 2-hydroxyethyl (meth)acrylate, glycidyl (meth)acrylate, and 2-isocyanatoethyl (meth)acrylate. In addition to ethylene and a functional (meth)acrylate monomer, other monomers may be copolymerized into such a polymer, such as vinyl acetate, unfunctionalized (meth)acrylate esters such as ethyl (meth)acrylate, n-butyl (meth)acrylate, and cyclohexyl (meth)acrylate.

Another example of the toughening agent is thermoplastic acrylic polymers that are not copolymers of ethylene. The thermoplastic acrylic polymers are made by polymerizing acrylic acid, acrylate esters (such as methyl acrylate, n-propyl acrylate, isopropyl acrylate, n-butyl acrylate, n-hexyl acrylate, and n-octyl acrylate), methacrylic acid, and methacrylate esters (such as methyl methacrylate, n-propyl methacrylate, isopropyl methacrylate, n-butyl methacrylate (BA), isobutyl methacrylate, n-amyl methacrylate, n-octyl methacrylate, glycidyl methacrylate (GMA) and the like). Copolymers derived from two or more of the forgoing types of monomers may also be used, as well as copolymers made by polymerizing one or more of the forgoing types of monomers with styrene, acrylonitrile, butadiene, isoprene, and the like. Part or all of the components in these copolymers should preferably have a glass transition temperature of not higher than 0° C. Preferred monomers for the preparation of a thermoplastic acrylic polymer toughening agent are methyl acrylate, n-propyl acrylate, isopropyl acrylate, n-butyl acrylate, n-hexyl acrylate, and n-octyl acrylate.

It is preferred that a thermoplastic acrylic polymer toughening agent have a core-shell structure. The core-shell structure is one in which the core portion preferably has a glass transition temperature of 0° C. or less, while the shell portion is preferably has a glass transition temperature higher than that of the core portion. The core portion may be grafted with silicone. The shell to section may be grafted with a low surface energy substrate such as silicone, fluorine, and the like. An acrylic polymer with a core-shell structure that has low surface energy substrates grafted to the surface will aggregate with itself during or after mixing with the thermoplastic polyester and other components of the composition of the invention and can be easily uniformly dispersed in the composition.

Other examples of the toughening agent are described in U.S. Pat. No. 4,174,358. Preferred toughening agents include polyolefins modified with a compatibilizing agent such as an acid anhydride, dicarboxylic acid or derivative thereof, carboxylic acid or derivative thereof, and/or an epoxy group. The compatibilizing agent may be introduced by grafting an unsaturated acid anhydride, dicarboxylic acid or derivative thereof, carboxylic acid or derivative thereof, and/or an epoxy group to a polyolefin. The compatibilizing agent may also be introduced while the polyolefin is being made by copolymerizing with monomers containing an unsaturated acid anhydride, dicarboxylic acid or derivative thereof, carboxylic acid or derivative thereof, and/or an epoxy group. The compatibilizing agent preferably contains from 3 to 20 carbon atoms. Examples of typical compounds that may be grafted to (or used as comonomers to make) a polyolefin are acrylic acid, methacrylic acid, maleic acid, fumaric acid, itaconic acid, crotonic acid, citraconic acid, maleic anhydride, itaconic anhydride, crotonic anhydride and citraconic anhydride.

Preferably there is about 0.5 to about 15 weight percent of the polymeric toughening agent in the composition, more preferably 4 to about 10 weight percent

### Other Components

The compositions of this invention may optionally include one or more plasticizers, nucleating agents, flame retardants, flame retardant synergists, heat stabilizers, antioxidants, dyes, pigments, mold release agents, lubricants, UV stabilizers, (paint) adhesion promoters, platy or granular fillers.

### Methods of Shaping a Thermoplastic Resin Composition

The compositions of the present invention are preferably in the form of a melt-mixed or a solution-mixed blend, more preferably melt-mixed, wherein all of the polymeric components are well-dispersed within each other and all of the non-polymeric ingredients are homogeneously dispersed in and bound by the polymer matrix, such that the blend forms a unified whole. The blend may be obtained by combining the component materials using any melt-mixing method or by mixing components other than matrix polymer with monomers of the polymer matrix and then polymerizing the monomers. The component materials may be mixed to homogeneity using a melt-mixer such as a single or twin-screw extruder, blender, kneader, Banbury mixer, etc. to give a resin composition. Part of the materials may be mixed in a melt-mixer, and the rest of the materials may then be added and further melt-mixed until homogeneous. The sequence of mixing in the manufacture of the thermally conductive polymer resin composition of this invention may be such that individual components may be melted in one shot, or the filler and/or other components may be fed from a side feeder, and the like, as will be understood by those skilled in the art.

The composition of the present invention may be formed into articles using methods known to those skilled in the art, such as, for example, injection molding, blow molding, extrusion, press molding. The present compositions are especially useful in electrical and/or electronic devices, sometimes forming in a sense metal/resin hybrids. Such articles can include those for use in motor housings, lamp housings, lamp housings in automobiles and other vehicles, electrical and electronic housings, insulation bobbin which exist between coiled wire and magnetic inducible metal core in stator of motors or generators, and housings which substantially encapsulates the stator core of motors or generators. Examples of lamp housings in automobiles and other vehicles are front and rear lights, including headlights, tail lights, and brake lights, particularly those that use light-emitting diode (LED) lamps. Examples of application in electric devices are reflector and frame of LED lights. The articles may serve as replacements for articles made from aluminum or other metals in many applications.

### Examples

These examples further illustrate but do not limit the invention.

### Compounding and Molding Methods

The polymeric compositions shown in Table 1 were prepared by compounding in a 32 mm Werner and Pfleiderer twin screw extruder. All ingredients were blended together and added to the rear of the extruder except that the magnesium oxide and the fillers were side-fed into a downstream barrel. Barrel temperatures were set at about 320° C. for HTN and 315° C. for PPS.

The compositions were molded into ISO test specimens on an injection molding machine for the measurement of mechanical properties and into plates of 1 mm×16 mm×16 mm size for measurements of thermal conductivity and CLTE. Melt temperature were about 325° C. and mold temperatures were about 150° C.

### Testing Methods

Tensile strength and elongation were measured using the ISO 527-1/2 standard method. Flexural strength and modulus were measured using the ISO 178-1/2 standard method. Notched charpy impact was measured using the ISO 179/1 eA standard method.

CLTE in mold flow direction were determined on about center portion of the plate in the temperature range from −40 to 150° C. using ASTM D696 method.

The standards for judging the tolerance so that composite members including both metal members and resin members will not separate due to the difference in coefficients of linear expansion was CLTE in mold flow direction/tensile elongation of test pieces bars=19 or lower. There appears to be a strong correlation with the changes in thermal conductivity and adhesiveness between the metal and the resin. It can be an indicator of improved adhesiveness and coincidentally with this, thermal conductivity. By monitoring the indicator, the difference in performance, employing the mixture of calcium fluoride and electrically insulative fibrous filler in the resins can be discerned.

Thermal conductivity was determined on the plate using Laser Flash Method as described in ASTM E1461. Results are shown in Table 1.

The following terms are used in Table 1:

HTN refers to Zytel® HTN501, a polyamide6TDT manufactured by E.I. du Pont de Nemours and Co., Wilmington, Del.
PPS refers to Ryton® PR26, a polyarylene sulfide manufactured by Chevron Phillips Chemical Company LP
2,6-NDA refers to 2,6-napthalene dicarboxylic acid, available from BP Amoco Chemical Company.
Talc refers to talc KOSSAP® #10 that is surface modified with an aminosilane coupling agent manufactured by Nippon Talc Co., Ltd.
CS-8CP is a calcium montanate supplied from Nitto Chemical Industry Co., ltd
Rubber-1 refers to TRX 301, an ethylene/propylene/hexadiene terpolymer grafted with maleic anhydride, was purchased from Dow Chemical (Midland, Mich., USA).
Rubber-2 refers to Engage8180, an ethylene/octene copolymer, was purchased from Dow Chemical (Midland, Mich., USA).
Ultranox 626A refers to bis(2,4-di-tert-butylphenyl pentaerythritol)diphosphite.
AO-80 refers to hindered phenol based antioxidant: (Asahi Denka Co.)
CaF2-A refers to calcium fluoride power having average particle size of 30 μm that was supplied from Sankyo Seifun.
CaF2-B refers to CaF2-A processed with 1 weight % amino silane coupling agent, Z-6011 manufactured by Dow Corning Toray.
CaF2-C refers to CaF2-A processed with 1 weight % epoxy silane coupling agent, Z-6040 manufactured by Dow Corning Toray.
GF-1 refers to FT756D, glass fibers manufactured by Owens Corning Japan Ltd. Tokyo, Japan. Diameter of the fiber is 10 μm, and its chopped fiber length is 3 mm.
GF-2 refers to ECS03T-747H, glass fibers manufactured by Nippon Electric Glass Co., Ltd. Owens Corning Japan Ltd. Diameter of the fibber is 10 μm, and its chopped fiber length is 3 mm.

| | Comp | | Comp | | | | Comp | Comp | Comp |
|---|---|---|---|---|---|---|---|---|---|
| | Ex1 | EX1 | EX2 | EX3 | EX4 | EX5 | EX3 | EX4 | EX5 |
| HTN (wt. %) | 37.1 | 37.1 | 37.1 | 37.1 | 34.2 | 31.3 | 37.1 | | |
| PPS (wt. %) | | | | | | | | 40 | 40 |
| 2,6-NDA (wt. %) | 1.2 | 1.2 | 1.2 | 1.2 | 1.1 | 1 | 1.2 | | |
| Talc (wt. %) | 1 | 1 | 1 | 1 | 1 | 1 | 1 | | |
| Rubber-1 (wt. %) | | | | | 2 | 4 | | | |
| Rubber-2 (wt. %) | | | | | 1 | 2 | | | |
| AO-80 (wt.) | 0.4 | 0.4 | 0.4 | 0.4 | 0.4 | 0.4 | 0.4 | | |
| Ultranox 626A (wt. %) | 0.2 | 0.2 | 0.2 | 0.2 | 0.2 | 0.2 | 0.2 | | |
| CS-8CP (wt. %) | 0.1 | 0.1 | 0.1 | 0.1 | 0.1 | 0.1 | 0.1 | | |
| CaF2-A (wt. %) | 36 | | | | | | | 36 | |
| CaF2-B (wt. %) | | 36 | 60 | 48 | 36 | 36 | | | |
| CaF2-C (wt. %) | | | | | | | | | 36 |
| GF-1 (wt. %) | 24 | 24 | | 12 | 24 | 24 | 60 | | |
| GF-2 (wt. %) | | | | | | | | 24 | 24 |
| Thermal Conductivity (W/mK) | 0.432 | 0.421 | 0.492 | 0.492 | 0.406 | 0.476 | 0.336 | 0.425 | 0.456 |
| Tensile strength (MPa) | 94 | 135 | 85 | 113 | 109 | 106 | 260 | 88 | 97 |
| Tensile elongation (%) | 0.8 | 1.4 | 1.3 | 1.5 | 1.2 | 1.7 | 1.9 | 0.9 | 1.1 |
| Flex Strength (MPa) | 139 | 205 | 129 | 169 | 156 | 162 | 412 | 144 | 155 |
| Flex Modulus (GPa) | 13.9 | 13.9 | 9.6 | 12.1 | 11.6 | 10.1 | 21.3 | 15.4 | 15.8 |
| Notched charpy (kJ/m2) | 3.3 | 2.9 | 2.1 | 2.2 | 4.0 | 4.8 | 16.5 | 2.9 | 2.6 |
| CLTE MD −40~160° C. | 21.5 | 23.2 | 47.5 | 28.4 | 19.1 | 16.1 | 12.1 | 22.5 | 21.7 |
| (ppm/° C.) | | | | | | | | | |
| CLTE/TE (ppm/° C. %) | 26.9 | 16.7 | 35.7 | 18.9 | 15.9 | 9.6 | 6.3 | 25.0 | 19.7 |

What is claimed is:

1. A thermally conductive polymer composition, comprising:
(a) about 15 to about 65 weight percent of hexamethylene terephthalamide/2-methylpentamethylene terephthalamide copolyamide (polyamide 6,T/D,T).
(b) about 20 to about 55 weight percent of calcium fluoride.
(c) about 10 to about 30 weight percent of at least one electrically insulative fibrous filler and
(d) 0 to about 15 weight percent of polymeric toughening agent.
wherein the calcium fluoride (b) is coated with a coupling agent selected from the group consisting of silane series, titanate series, zirconate series, aluminate series, and zircoaluminate series and the composition is characterized by the fact that a ratio of coefficients of linear thermal expansion (CLTEs) in the mold flow direction (MD) of a molded article made therefrom to its tensile elongation is 19 ppm/° C.•% or lower, wherein the CLTE is measured between −40 and 150° C. using ASTM D696 method.

2. The composition of claim 1 wherein said coupling agent is a silane coupling agent in the amount of from 0.1 to 5 weight percentage with respect to the weight of said calcium fluoride (b).

3. The composition of claim 2 wherein said silane coupling agent is amino silane coupling agent.

4. The composition of claim 1 wherein said at least one fibrous filler (c) is independently selected from the group consisting of glass fibers, wallastonites, titanium oxide fiber and alumina fiber.

5. The composition of claim 1 wherein said polyamide (a) has a glass transition temperature of at least 100° C.

6. The composition of claim 1 wherein the polymeric toughening agent is present in about 4 to about 10 weight percent, based on the total weight of the composition

7. An article made from the composition of claim 1.

8. A metal/polymer hybrid article made with the composition of claim 1.
